(19) United States
(12) Patent Application Publication
(10) Pub. No.: US 2026/0227426 A1
(43) Pub. Date: Aug. 6, 2026

(54) METROLOGY METHOD AND ASSOCIATED METROLOGY DEVICE

(71) Applicant: ASML Netherlands B.V., Veldhoven (NL)

(72) Inventors: Mustafa Ümit ARABUL, Eindhoven (NL); Zili ZHOU, Veldhoven (NL); Nitesh PANDEY, Silicon Valley, CA (US); Coen Adrianus VERSCHUREN, Eindhoven (NL); Willem Marie Julia Marcel COENE, Veldhoven (NL); Peter Gerard STEENEKEN, Delfgauw (NL); Gerard Jan VERBIEST, Chaam (NL)

(73) Assignee: ASML Netherlands B.V., Veldhoven (NL)

(21) Appl. No.: 19/149,267

(22) PCT Filed: Jan. 17, 2024
(86) PCT No.: PCT/EP2024/051014

§ 371 Date: Jul. 18, 2025

Related U.S. Application Data
(60) Provisional application No. 63/445,420, filed on Feb. 14, 2023.

(51) Int. Cl. G01Q 60/32; G01Q 70/10; G01Q 70/14

(52) U.S. Cl. CPC G01Q 60/32; G01Q 70/10; G01Q 70/14

(57) ABSTRACT

Disclosed is a cantilever probe arrangement for a photoacoustic sub-surface atomic force microscope comprising: a cantilever arm; at least one probe element attached to the cantilever arm and comprising a cross-sectional area which decreases away from the cantilever arm towards a tip of the probe element; and at least one focusing structure operable to focus acoustic waves generated on the cantilever arm on said tip of the at least one probe element.

### CROSS-REFERENCE TO RELATED APPLICATIONS

This application claims priority of U.S. application 63/445,420 which was filed on 14 Feb. 2023 and which is incorporated herein in its entirety by reference.

### FIELD

The present invention relates to a metrology method and device which may, for example, be used for determining a characteristic of structures on a substrate.

### BACKGROUND

A lithographic apparatus is a machine constructed to apply a desired pattern onto a substrate. A lithographic apparatus can be used, for example, in the manufacture of integrated circuits (ICs). A lithographic apparatus may, for example, project a pattern (also often referred to as “design layout” or “design”) at a patterning device (e.g., a mask) onto a layer of radiation-sensitive material (resist) provided on a substrate (e.g., a wafer).

To project a pattern on a substrate a lithographic apparatus may use electromagnetic radiation. The wavelength of this radiation determines the minimum size of features which can be formed on the substrate. Typical wavelengths currently in use are 365 nm (i-line), 248 nm, 193 nm and 13.5 nm. A lithographic apparatus, which uses extreme ultraviolet (EUV) radiation, having a wavelength within the range 4-20 nm, for example 6.7 nm or 13.5 nm, may be used to form smaller features on a substrate than a lithographic apparatus which uses, for example, radiation with a wavelength of 193 nm.

Low-k₁ lithography may be used to process features with dimensions smaller than the classical resolution limit of a lithographic apparatus. In such process, the resolution formula may be expressed as CD=k₁×λ/NA, where λ is the wavelength of radiation employed, NA is the numerical aperture of the projection optics in the lithographic apparatus, CD is the “critical dimension” (generally the smallest feature size printed, but in this case half-pitch) and kᵢ is an empirical resolution factor. In general, the smaller kᵢ the more difficult it becomes to reproduce the pattern on the substrate that resembles the shape and dimensions planned by a circuit designer in order to achieve particular electrical functionality and performance. To overcome these difficulties, sophisticated fine-tuning steps may be applied to the lithographic projection apparatus and/or design layout. These include, for example, but not limited to, optimization of NA, customized illumination schemes, use of phase shifting patterning devices, various optimization of the design layout such as optical proximity correction (OPC, sometimes also referred to as “optical and process correction”) in the design layout, or other methods generally defined as “resolution enhancement techniques” (RET). Alternatively, tight control loops for controlling a stability of the lithographic apparatus may be used to improve reproduction of the pattern at low k1.

In lithographic processes, it is desirable to make frequently measurements of the structures created, e.g., for process control and verification. Various tools for making such measurements are known, including scanning electron microscopes or various forms of metrology apparatuses, such as scatterometers. A general term to refer to such tools may be metrology apparatuses or inspection apparatuses.

Metrology tools are known that can measure overlay in target structures having pitches down to around 10 nm if the separation between the overlying layers (e.g. gratings formed in different layers) is of a similar order of size. Metrology tools are also known that can measure overlay between overlying layers that are spaced further apart, but only if the pitch of the target structures is also commensurately larger. It has been difficult to measure overlay in target structures having relatively small pitch (e.g. around 10 nm) and relatively large separation between the overlying layers (e.g. greater than 100 nm). A further challenge is the increasing use of material layers that are not transparent to visible light, such as metal or carbon layers, or chalcogenide materials used for example in 3D memory applications. Portions of target structures below such opaque layers may not be accessible to many existing metrology techniques based on scatterometry.

A particular metrology technique, referred to herein as photoacoustic sub-surface atomic force microscopy (passAFM), and an associated metrology apparatus is described in WO2021028174A1, which is incorporated herein by reference. This technique was devised to address one or more of the issues highlighted in the previous paragraph.

In the passAFM technique, an AFM cantilever is used as a very high frequency ultrasound transducer (e.g., at a frequency of about 100 GHz). This transducer is actuated via an optical pump pulse on the cantilever. The generated acoustic waves enter the sample via the cantilever tip, and reflected echoes are detected when they arrive back at the cantilever surface via an optical probe beam (e.g., displacement or reflectivity).

It is desirable to improve methods of performing such photoacoustic sub-surface atomic force microscopy.

### SUMMARY

Embodiments of the invention are disclosed in the claims and in the detailed description.

In a first aspect of the invention there is provided a cantilever probe arrangement for a photoacoustic sub-surface atomic force microscope comprising: a cantilever arm; at least one probe element attached to the cantilever arm and comprising a cross-sectional area which decreases away from the cantilever arm towards a tip of the probe element; and at least one focusing structure operable to focus acoustic waves generated on the cantilever arm on said tip of the at least one probe element.

The invention yet further provides a photoacoustic sub-surface atomic force microscope comprising the cantilever probe arrangement of the first aspect.

These and other aspects and advantages of the apparatus and methods disclosed herein will be appreciated from a consideration of the following description and drawings of exemplary embodiments.

### BRIEF DESCRIPTION OF THE DRAWINGS

Embodiments of the invention will now be described, by way of example only, with reference to the accompanying schematic drawings, in which:

FIG. 1 depicts a schematic overview of a lithographic apparatus;

FIG. 2 depicts a schematic overview of a lithographic cell;

FIG. 3 depicts a schematic representation of holistic lithography, representing a cooperation between three key technologies to optimize semiconductor manufacturing;

FIG. 4 is schematic side view of a metrology tool having a cantilever probe, an ultrasound generation system, and an ultrasound detection system;

FIG. 5 is a schematic side sectional view of a probe element in a transmit mode;

FIG. 6 is a schematic side sectional view of the probe element of FIG. 4 in a receive mode;

FIG. 7 is an illustration in (a) oblique view and (b) side view of a cantilever probe arrangement according to a first embodiment;

FIG. 8 is a schematic illustration of a probe arrangement according to a second embodiment;

FIG. 9 is a schematic illustration of alternative zone plate arrangements for use in embodiments such as illustrated in FIGS. 7 and 8;

FIG. 10 is a schematic illustration of a probe element according to a third embodiment;

FIG. 11 is a schematic illustration of (a) a probe element of conventional shape and (b) a probe element according to an embodiment; and

FIG. 12 is a schematic illustration of a pair of probe elements according to an embodiment.

### DETAILED DESCRIPTION

In the present document, the terms “radiation” and “beam” are used to encompass all types of electromagnetic radiation, including ultraviolet radiation (e.g. with a wavelength of 365, 248, 193, 157 or 126 nm) and EUV (extreme ultra-violet radiation, e.g. having a wavelength in the range of about 5-100 nm).

The term “reticle”, “mask” or “patterning device” as employed in this text may be broadly interpreted as referring to a generic patterning device that can be used to endow an incoming radiation beam with a patterned cross-section, corresponding to a pattern that is to be created in a target portion of the substrate. The term “light valve” can also be used in this context. Besides the classic mask (transmissive or reflective, binary, phase-shifting, hybrid, etc.), examples of other such patterning devices include a programmable mirror array and a programmable LCD array.

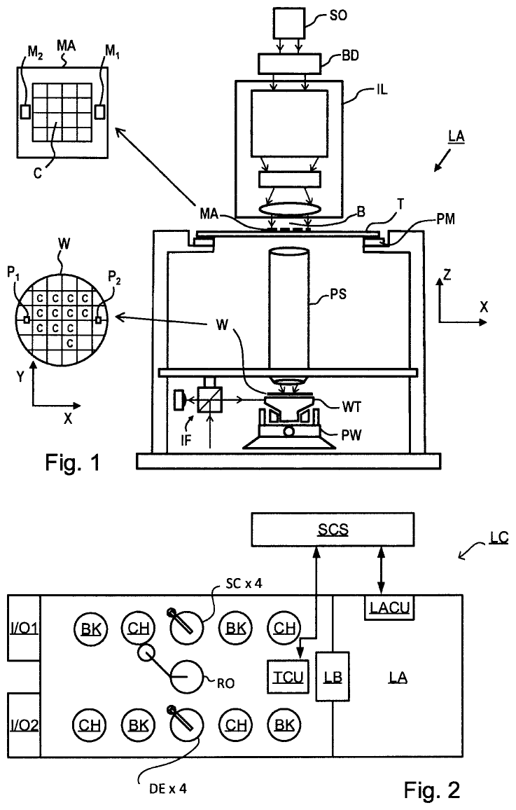

FIG. 1 schematically depicts a lithographic apparatus LA. The lithographic apparatus LA includes an illumination system (also referred to as illuminator) IL configured to condition a radiation beam B (e.g., UV radiation, DUV radiation or EUV radiation), a mask support (e.g., a mask table) MT constructed to support a patterning device (e.g., a mask) MA and connected to a first positioner PM configured to accurately position the patterning device MA in accordance with certain parameters, a substrate support (e.g., a wafer table) WT constructed to hold a substrate (e.g., a resist coated wafer) W and connected to a second positioner PW configured to accurately position the substrate support in accordance with certain parameters, and a projection system (e.g., a refractive projection lens system) PS configured to project a pattern imparted to the radiation beam B by patterning device MA onto a target portion C (e.g., comprising one or more dies) of the substrate W.

In operation, the illumination system IL receives a radiation beam from a radiation source SO, e.g. via a beam delivery system BD. The illumination system IL may include various types of optical components, such as refractive, reflective, magnetic, electromagnetic, electrostatic, and/or other types of optical components, or any combination thereof, for directing, shaping, and/or controlling radiation. The illuminator IL may be used to condition the radiation beam B to have a desired spatial and angular intensity distribution in its cross section at a plane of the patterning device MA.

The term “projection system” PS used herein should be broadly interpreted as encompassing various types of projection system, including refractive, reflective, catadioptric, anamorphic, magnetic, electromagnetic and/or electrostatic optical systems, or any combination thereof, as appropriate for the exposure radiation being used, and/or for other factors such as the use of an immersion liquid or the use of a vacuum. Any use of the term “projection lens” herein may be considered as synonymous with the more general term “projection system” PS.

The lithographic apparatus LA may be of a type wherein at least a portion of the substrate may be covered by a liquid having a relatively high refractive index, e.g., water, so as to fill a space between the projection system PS and the substrate W—which is also referred to as immersion lithography. More information on immersion techniques is given in U.S. Pat. No. 6,952,253, which is incorporated herein by reference.

The lithographic apparatus LA may also be of a type having two or more substrate supports WT (also named “dual stage”). In such “multiple stage” machine, the substrate supports WT may be used in parallel, and/or steps in preparation of a subsequent exposure of the substrate W may be carried out on the substrate W located on one of the substrate support WT while another substrate W on the other substrate support WT is being used for exposing a pattern on the other substrate W.

In addition to the substrate support WT, the lithographic apparatus LA may comprise a measurement stage. The measurement stage is arranged to hold a sensor and/or a cleaning device. The sensor may be arranged to measure a property of the projection system PS or a property of the radiation beam B. The measurement stage may hold multiple sensors. The cleaning device may be arranged to clean part of the lithographic apparatus, for example a part of the projection system PS or a part of a system that provides the immersion liquid. The measurement stage may move beneath the projection system PS when the substrate support WT is away from the projection system PS.

In operation, the radiation beam B is incident on the patterning device, e.g. mask, MA which is held on the mask support MT, and is patterned by the pattern (design layout) present on patterning device MA. Having traversed the mask MA, the radiation beam B passes through the projection system PS, which focuses the beam onto a target portion C of the substrate W. With the aid of the second positioner PW and a position measurement system IF, the substrate support WT can be moved accurately, e.g., so as to position different target portions C in the path of the radiation beam B at a focused and aligned position. Similarly, the first positioner PM and possibly another position sensor (which is not explicitly depicted in FIG. 1) may be used to accurately position the patterning device MA with respect to the path of the radiation beam B. Patterning device MA and substrate W may be aligned using mask alignment marks M1, M2 and substrate alignment marks P1, P2. Although the substrate alignment marks P1, P2 as illustrated occupy dedicated target portions, they may be located in spaces between target portions. Substrate alignment marks P1, P2 are known as scribe-lane alignment marks when these are located between the target portions C.

As shown in FIG. 2 the lithographic apparatus LA may form part of a lithographic cell LC, also sometimes referred to as a lithocell or (litho)cluster, which often also includes apparatus to perform pre- and post-exposure processes on a substrate W. Conventionally these include spin coaters SC to deposit resist layers, developers DE to develop exposed resist, chill plates CH and bake plates BK, e.g. for conditioning the temperature of substrates W e.g. for conditioning solvents in the resist layers. A substrate handler, or robot, RO picks up substrates W from input/output ports I/O1, I/O2, moves them between the different process apparatus and delivers the substrates W to the loading bay LB of the lithographic apparatus LA. The devices in the lithocell, which are often also collectively referred to as the track, are typically under the control of a track control unit TCU that in itself may be controlled by a supervisory control system SCS, which may also control the lithographic apparatus LA, e.g. via lithography control unit LACU.

In order for the substrates W exposed by the lithographic apparatus LA to be exposed correctly and consistently, it is desirable to inspect substrates to measure properties of patterned structures, such as overlay errors between subsequent layers, line thicknesses, critical dimensions (CD), etc. For this purpose, inspection tools (not shown) may be included in the lithocell LC. If errors are detected, adjustments, for example, may be made to exposures of subsequent substrates or to other processing steps that are to be performed on the substrates W, especially if the inspection is done before other substrates W of the same batch or lot are still to be exposed or processed.

An inspection apparatus, which may also be referred to as a metrology apparatus, is used to determine properties of the substrates W, and in particular, how properties of different substrates W vary or how properties associated with different layers of the same substrate W vary from layer to layer. The inspection apparatus may alternatively be constructed to identify defects on the substrate W and may, for example, be part of the lithocell LC, or may be integrated into the lithographic apparatus LA, or may even be a stand-alone device. The inspection apparatus may measure the properties on a latent image (image in a resist layer after the exposure), or on a semi-latent image (image in a resist layer after a post-exposure bake step PEB), or on a developed resist image (in which the exposed or unexposed parts of the resist have been removed), or even on an etched image (after a pattern transfer step such as etching).

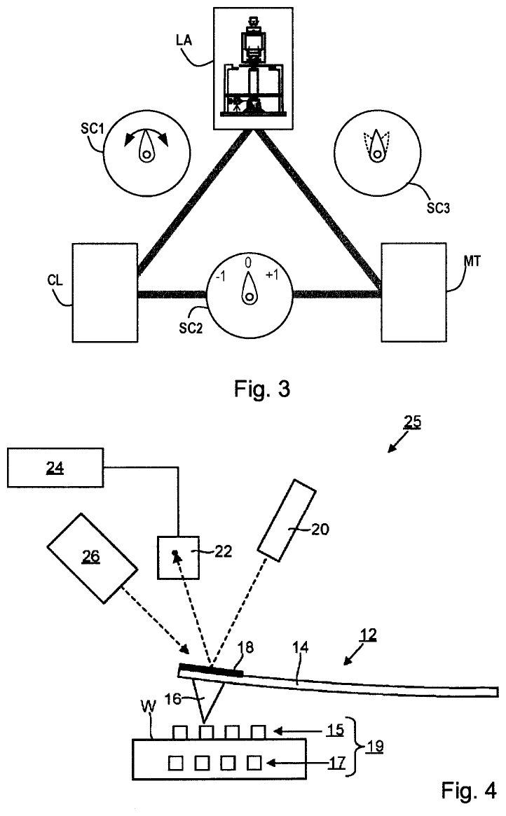

Typically the patterning process in a lithographic apparatus LA is one of the most critical steps in the processing which requires high accuracy of dimensioning and placement of structures on the substrate W. To ensure this high accuracy, three systems may be combined in a so called “holistic” control environment as schematically depicted in FIG. 3. One of these systems is the lithographic apparatus LA which is (virtually) connected to a metrology tool MET (a second system) and to a computer system CL (a third system). The key of such “holistic” environment is to optimize the cooperation between these three systems to enhance the overall process window and provide tight control loops to ensure that the patterning performed by the lithographic apparatus LA stays within a process window. The process window defines a range of process parameters (e.g. dose, focus, overlay) within which a specific manufacturing process yields a defined result (e.g. a functional semiconductor device)—typically within which the process parameters in the lithographic process or patterning process are allowed to vary.

The computer system CL may use (part of) the design layout to be patterned to predict which resolution enhancement techniques to use and to perform computational lithography simulations and calculations to determine which mask layout and lithographic apparatus settings achieve the largest overall process window of the patterning process (depicted in FIG. 3 by the double arrow in the first scale SC1). Typically, the resolution enhancement techniques are arranged to match the patterning possibilities of the lithographic apparatus LA. The computer system CL may also be used to detect where within the process window the lithographic apparatus LA is currently operating (e.g. using input from the metrology tool MET) to predict whether defects may be present due to e.g. sub-optimal processing (depicted in FIG. 3 by the arrow pointing “0” in the second scale SC2).

The metrology tool MET may provide input to the computer system CL to enable accurate simulations and predictions, and may provide feedback to the lithographic apparatus LA to identify possible drifts, e.g. in a calibration status of the lithographic apparatus LA (depicted in FIG. 3 by the multiple arrows in the third scale SC3).

In lithographic processes, it is desirable to make frequently measurements of the structures created, e.g., for process control and verification. Various tools for making such measurements are known, including scanning electron microscopes or various forms of metrology apparatuses, such as scatterometers.

FIG. 4 is a schematic illustration of a metrology apparatus described in WO2021028174A1. The apparatus comprises a cantilever probe 12 configured to provide high spatial resolution information about features present below an outer surface of an entity to be investigated with minimal or no risk of damage to the entity. The cantilever probe 12 is provided as part of a measurement system 25. In some embodiments, examples of which are given below, the entity to be investigated is a target structure 19 formed on a substrate W using a lithographic process. In such embodiments, the measurement system 25 may be referred to as a metrology tool.

In an embodiment, the cantilever probe 12 comprises a cantilever arm 14 and a probe element 16. The probe element 16 extends from the cantilever arm 14 towards the target structure 19 on the substrate W (generally downwards in FIG. 4). In an embodiment, the cantilever arm 14 and probe element 16 are configured (e.g. via their material properties and dimensions) to be capable of performing the functions of the cantilever in a standard atomic force microscope. In an embodiment, either or both of the cantilever arm 14 and probe element 16 is/are formed from silicon.

In an embodiment, the measurement system 25 is configured to generate ultrasonic waves in the cantilever probe 12. The ultrasonic waves propagate through the probe element 16 and into the target structure 19. The ultrasonic waves are reflected back from the target structure 19 into the probe element 16 or into a further probe element 32 (described below) extending from the cantilever arm 14.

In an embodiment, the ultrasonic waves are generated in the cantilever probe 12 using the photoacoustic effect. In some embodiments of this type, the generation of the ultrasonic waves is performed by directing a laser beam onto the cantilever probe 12. In the example of FIG. 4, a laser beam is directed onto the cantilever probe 12 by a first laser unit 26. The first laser unit 26 may be considered as forming all or part of an ultrasound generation system.

The nature of the laser beam provided by the first laser unit 26 is not particularly limited as long as the required ultrasonic waves are generated. The laser beam may, for example, comprise a femtosecond laser. In one embodiment, a laser pulse of between 10 fs and 900 fs, or between 10 fs and 500 fs, between 100 fs and 500 fs, between 100 fs and 300 fs or approximately 200 fs may be used. The laser pulse may have a pulse energy of between 1 nJ and 10 nj (e.g., approx. 6 nJ) for example. By way of a specific example, the pulse may comprise a peak power of 30 kW. The repetition rate of this pulse may be between 10 MHz and 100 MHz (e.g., approximately 50 MHz) and the average power between 100 mW and 1 W (e.g., on the order of 300 mW).

In an embodiment, as exemplified in FIG. 4, an ultrasound generation layer or acoustic generation layer 18 is provided on the cantilever arm 14. The laser beam from the first laser unit 26 is directed onto the ultrasound generation layer 18 to generate ultrasonic waves in the ultrasound generation layer 18. In embodiments of this type, the combination of the first laser unit 26 and the ultrasound generation layer 18 may be considered as forming all or part of an ultrasound generation system. In an embodiment, the ultrasound generation layer 18 is configured to provide higher absorbance per unit area with respect to the laser beam from the first laser unit 26 than would the cantilever arm 14 in the absence of the ultrasound generation layer 18. It is also desirable for the photoacoustic conversion efficiency associated with the absorption to be high and stable. The ultrasound generation layer 18 desirably has both a high absorbance per unit area at the frequency of the laser beam from the first laser unit 20 and a thermal diffusion speed of the same order of magnitude as the laser pulse duration (e.g. of the order of femtoseconds) for high photoacoustic conversion efficiency. In an embodiment, the ultrasound generation layer 18 may comprise a metallic material, such as aluminium, gold or titanium. Alternatively or additionally, the ultrasound generation layer 18 may be arranged to comprise highly absorbing carbon-based materials, such as amorphous carbon. The ultrasound generation layer 18 may comprise a single layer having uniform composition through the thickness of the single layer. Alternatively, the ultrasound generation layer 18 may comprise a composite layer having multiple individual layers. In an embodiment, at least a subset of the individual layers have different compositions relative to each other. It is also desirable to arrange for efficient transmission of the generated ultrasonic waves, for example by avoiding excessive reflection at interfaces within the ultrasound generation layer 18 and/or between the ultrasound generation layer 18 and the cantilever arm 14. This can be achieved by reducing the size of acoustic impedance mismatches at the interfaces. In an embodiment, an impedance-matching layer is provided between the ultrasound generation layer 18 and the cantilever arm 14. The acoustic impedance of the impedance-matching layer is between an acoustic impedance of the ultrasound generation layer 18 and an acoustic impedance of the cantilever arm 14.

In an embodiment, the composition and dimensions of the ultrasound generation layer 18 are selected so that at least a portion of the ultrasonic waves generated in the ultrasound generation layer 18 have a frequency higher than 15 GHz, optionally higher than 50 GHz, optionally higher than 100 GHz. Providing ultrasonic waves in the range of 15 GHz to 50 GHz provides sub-micron resolution of spatial features within the target structure 19. Providing ultrasonic waves having a frequency higher than 100 GHz (e.g. in the range of 100 GHz to 200 GHz) provide nanometer resolution of spatial features within the target structure 19. Providing ultrasonic waves in the intermediate range of 50 GHz to 100 GHz provides intermediate resolution of spatial features.

The thickness of the ultrasound generation layer 18 may influence the frequency of the generated ultrasound. When the thickness of the ultrasound generation layer 18 is comparable to or smaller than the skin depth (with respect to the laser beam from the first laser unit 26), the thickness t of the ultrasound generation layer 18 and the frequency f of the ultrasound may be related according to f=v/2t when v is the speed of sound in the ultrasound generation layer 18. If the thickness t is larger than the skin depth, the skin depth acts as a bottle neck. The skin depth is determined by the complex refractive index of the ultrasound generation layer 18.

Based on the above, forming the ultrasound generation layer 18 from a homogeneous layer of aluminium having a thickness of e.g., 30 nm, or a homogeneous layer of amorphous carbon having a thickness of 85 nm or less, would be suitable for generating ultrasonic waves have frequencies above 100 GHz. As explained above, the required thicknesses depend on the speed of sound in the ultrasound generation layer 18. With higher speeds of sound it possible to generate higher frequency ultrasound from the same thickness of material. However, increasing the speed of sound may also increase reflection losses at boundaries (where present) within the ultrasound generation layer 18 and/or between the ultrasound generation layer 18 and the cantilever arm 14. The thickness of the ultrasound generation layer 18 will typically be less than 500 nm, optionally less than 250 nm, optionally less than 100 nm, optionally less than 50 nm.

In some embodiments, the shape of the ultrasound generation layer 18 is configured to modify the nature (e.g. frequency) of the generated ultrasound and/or enhance the conversion efficiency. For example, the ultrasound generation layer 18 may comprise one or more patterns having features at length scales smaller than the wavelength of the laser beam from the first laser unit 26. In some embodiments, the ultrasound generation layer 18 may comprise one or more loops of material, optionally closed loops, optionally concentric circles. Alternatively, the ultrasound generation layer 18 may be provided as a checker-board pattern. Detailed dimensions and/or shapes of any of the ultrasound generation layers 18 configured in this way may be derived from vibrational mode analyses of the ultrasound generation layers 18.

In an embodiment, an ultrasound detection system is provided that detects the reflected ultrasonic waves reflected back from the target structure 19. In some embodiments, the detection of the reflected ultrasonic waves comprises detecting changes in an optical reflectivity of the cantilever probe 12. In the example of FIG. 4, the ultrasound detection system comprises an electromagnetic detection system, in turn comprising a second laser unit 20 and photodetector 22. The second laser unit 20 directs a laser beam onto the cantilever probe 12. In the embodiment shown, the laser beam is directed onto the ultrasound generation layer 18. The laser beam is reflected off the cantilever probe 12 (e.g. off the ultrasound generation layer 18) and detected by the photodetector 22. A data processing system 24 is provided for determining information about the target structure 19 from the detected reflected ultrasonic waves.

In an embodiment, signal acquisition is performed in a pulse-echo imaging mode that switches between a transmit mode and a receive mode. In the transmit mode, first laser unit 26 generates ultrasonic waves in the cantilever probe 12. The generated ultrasonic waves are transmitted into the target structure 19 by contact between the cantilever probe 12 and the target structure 19 (e.g. via the probe element 16 of the cantilever probe 12). In the receive mode, the second laser unit 20 probes the reflectivity of the cantilever probe 12 (e.g. by directing a laser beam onto the ultrasound generation layer 18 that is reflected and detected by the photodetector 22). This approach makes it possible to distinguish easily between light reflected to the photodetector 22 from the first laser unit 26 and light reflected to the photodetector 22 from the second laser unit 20 because the first laser unit 26 and the second laser unit 20 are operational at different times. It is also possible, however, to transmit and receive the ultrasonic waves continually and use other techniques to distinguish reflections originating from the first laser unit 26 from reflections originating from the second laser unit 20. For example, the data processing system 24 may be configured to use lock-in amplifier or similar techniques to exploit frequency and/or phase differences between the laser beams from the first laser unit 26 and the second laser unit 20. In the embodiment shown in FIG. 4, the first laser unit 26 and the second laser unit 20 are separate devices. This is advantageous because the characteristics desired for the laser beam of the first laser unit 26 (e.g. high power) are normally different to the characteristics desired for the laser beam of the second laser unit 20 (e.g. lower power). In other embodiments, however, the first laser unit 26 and the second laser unit 20 may be provided by a single unit which generates laser light that is used both for generating the ultrasonic waves and detected changes in optical reflectivity containing information about ultrasonic waves reflected back from the target structure 19.

In an embodiment, the ultrasound detection system (e.g. the second laser unit 20 and the photodetector 22) is further configured to measure a deflection of the cantilever probe 12. This may be achieved for example by monitoring a variation in the position of a reflected radiation spot on the photodetector 22.

In comparison with alternative approaches in which ultrasonic waves are generated directly within the target structure 19, for example by an actuator on a back side of the target structure 19 opposite to an atomic force microscope cantilever, the above embodiments provide several advantages.

Generating the ultrasonic waves directly in the target structure 19 can lead to errors caused by material dependent factors of the target structure 19. Furthermore, the highest acoustic frequency that is achievable is limited by the material properties of the target structure 19. Furthermore, the target structure 19 may be damaged by the process of generating the ultrasonic waves, which effectively limits the maximum power that can be used. Generating the ultrasonic waves in the cantilever arm 12 makes it possible to avoid these problems, thereby providing improved accuracy, improved spatial resolution via higher ultrasound frequencies, lower risk of damage to the target structure 19 and/or higher input powers without excessive risk of damage.

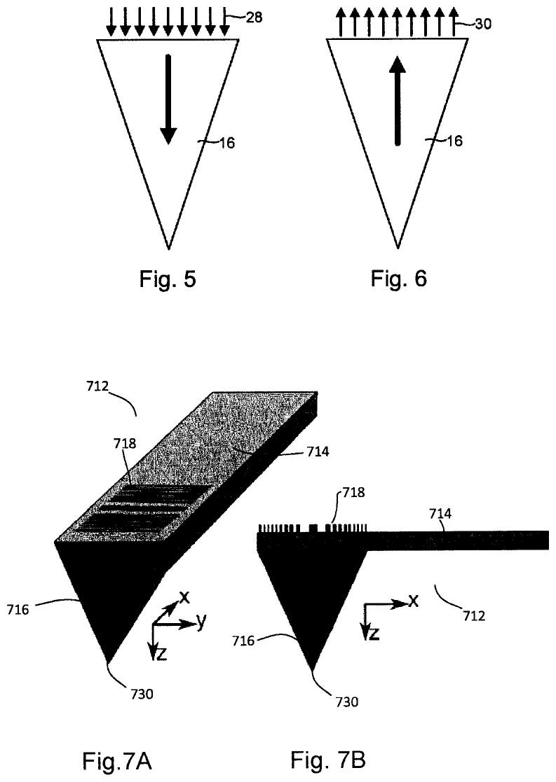

FIG. 5 depicts a probe element 16 operating in a transmit mode, with generated ultrasonic waves 28 entering the probe element 16 from the cantilever arm 14 (not shown) and propagating downwards through the probe element 16. FIG. 6 depicts the probe element 16 of FIG. 5 operating in receive mode, with reflected ultrasonic waves propagating upwards through the probe element 16 and leaving the probe element 16 (arrows 30) into the cantilever arm 14 (not shown). The probe element 16 is an example of a probe element that is tapered to have a cross-sectional area that decreases towards the target structure 19 (i.e. downwards). In this particular example, the tapering is provided over the whole vertical length of the probe element 16. The cross-sectional shape is not particularly limited but may be approximately circular for example, such that the tapered portion of the probe element 16 is conical. The tapered form acts to focus the ultrasonic waves 28 towards the target structure 19. However, the tapered form can also act to defocus reflected ultrasonic waves, making detection of the reflected ultrasonic waves more challenging. In an embodiment the probe element 16 is formed from alternating layers of materials having high and low acoustic refractive index. High acoustic refractive index material is Silicon, for example. Low acoustic refractive material may be air or PMMA, for example. The acoustic properties of the element 16 when formed from alternating layers of materials having high and low acoustic refractive index may be further controlled or improved by adjusting the pitch of the alternating layers or the filing ratio or the thickness of each layer.

Other embodiments are disclosed and described in WO2021028174A1, many of which are applicable to the concepts disclosed herein; for example providing respective separate probe elements for directing the ultrasonic waves into the target structure and receiving the reflected ultrasonic waves.

The focusing provided by the tapered form of the probe element 16 results in the propagation of ultrasonic waves (or acoustic waves) in the target structure 19 resembling propagation from a point source. Three-dimensional radiation from a point source results in the intensity falling inversely proportional to r², where r is the emission radius. The intensity reaching the bottom of the target structure 19 is thus reduced by a factor of t², where t is the thickness of the target structure 19. In the absence of counter measures, the reflected intensity reaching the top of the target structure 19 will thus be reduced by a factor of t⁴ in comparison with the transmission intensity of the ultrasonic waves at the tip of the probe element 16.

To address this issue, it is proposed to configure the cantilever probe 12, so as to at least better direct the acoustic waves or ultrasonic waves towards the probe element tip. For example, the cantilever probe may be configured to at least partially focus the generated acoustic waves at the probe element tip. This may be achieved by providing a focusing structure such as a convex acoustic lens or zone plate (Fresnel lens) on or within the cantilever probe.

The proposed configuration may additionally better direct the reflected ultrasonic waves from the target on the return path, e.g., towards a detection region where the reflected wave is measured such as a detection region on the cantilever arm (e.g., where the second laser unit 20 and the photodetector 22, illustrated in FIG. 4 and equally applicable to all embodiments disclosed herein, are together used to measure deflection of the cantilever arm caused by the reflected waves). For example, the focusing structure may be further configured to at least partially focus the reflected acoustic waves towards this detection region.

The zone plate or Fresnel lens concept is a well-known concept which may be used to focus waves such as electromagnetic waves and/or acoustic waves. Although the separation of the structures in the zone plate structure may be determined according to Equation (1) below, it is possible to achieve wave focusing by providing a structure with a non-constant or varied pitch (in one, two or more directions of the substrate plane).

As such, the term zone plate as described herein should be understood to mean any structure with a non-constant pitch in at least one direction, the effect of the non-constant pitch being that waves generated on and/or transmitted through the structure are at least partially focused towards at least a first focal point (e.g., at or near the probe element tip) and optionally at a second focal point (e.g., at or near a detection point) for the reflected wave on the return path.

FIG. 7 illustrates a cantilever probe 712 according to an embodiment in two views. This cantilever probe, and the other cantilever probes disclosed herein, may form part of a passAFM metrology apparatus as described in WO2021028174A1, in place of the cantilever probe 12 illustrated therein. The cantilever probe comprises a cantilever arm 714 and probe element 716 which operate essentially as has already been described in relation to the cantilever arm 14 and probe element 16 of FIGS. 4 to 6.

However, in this embodiment, the ultrasound generation surface or acoustic generation surface (where the acoustic generation takes place) comprises a zone plate structure 718. For example, the cantilever surface may be coated or etched with a zone plate absorber arrangement or pattern. In an embodiment, this may be achieved via ion beam etching or sputtering, for example.

In such an embodiment, it may be assumed (for example) that the pump laser radiation is absorbed on only the ultrasound generation region (or layer) comprising zone plate structure 718. Due to the zone plate effect, the generated ultrasonic waves will be focused towards the tip 730 of the probe element 716. The geometry of the zone plate (e.g., pitch, height of each individual feature etc.) and/or its acoustic properties (e.g., using different materials for different lines) may be tuned to focus the waves at the tip 730. The zone plate structure may comprise absorber material such as one or more metals; e.g., one or more of: aluminum, gold, carbon, graphene etc., based on their optical and elastic properties.

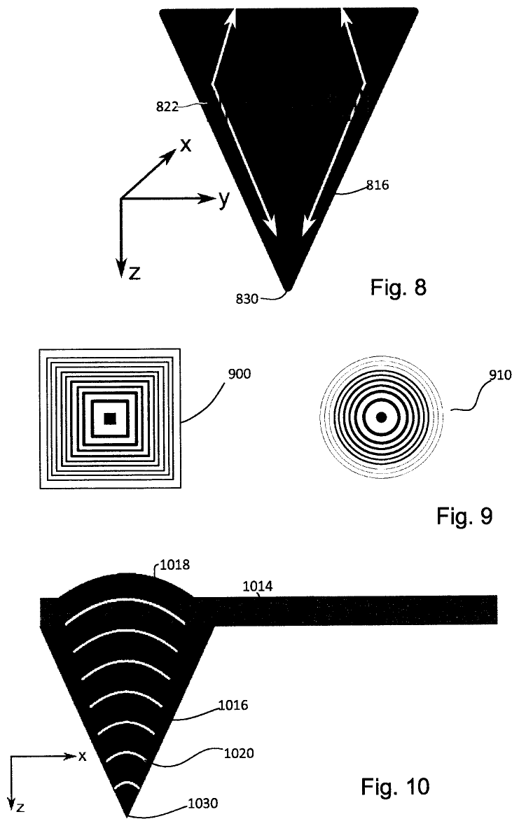

FIG. 8 is an illustration of a probe element 816 according to another embodiment. In this embodiment, the focusing structure or zone plate structure 822 is embedded within the probe element 816; i.e., between the ultrasound generation region/detection region and the tip 830 of the probe element 816. This zone plate structure 822 still acts to focus the generated ultrasonic waves toward the tip 830 of the probe element 816 on the outward direction (e.g., to a target being measured). However, the zone plate structure 822 now also focusses the reflected waves on the return path towards a detection region (e.g., a cantilever surface where they will be measured, this may be the same region as the ultrasound generation region). As such, the zone plate structure 822 focuses the ultrasonic waves in both transmit and receive directions.

In an embodiment, this zone plate structure 822 may be located approximately half way between the ultrasound generation region/detection region and the tip 730 of the probe element 816. This increases the effective signal strength, and reduces undesirable reflections inside the probe element 816 that would complicated subsequent signal processing.

The zone plate structure 822 acts similarly to a single lens in the tip, imaging the spot from tip to the cantilever, or vice versa. According to the single lens magnification equation, for example, when the zone plate structure 822 is approximately half way between the ultrasound generation region/detection region and the tip 730, the magnification will be M=1. Having M=1 is not always ideal since the acoustic ‘spot’ from the tip is mostly smaller than the one on the cantilever. The former is defined by the size of the tip area, i.e., <1 m, the latter is preferably similar to the size of the probe/pump laser spot for the highest probe/pump efficiency, i.e., a few to 10's μm. Therefore in another embodiment it may be preferred to have a magnification M>1 or M>>1 (e.g., M>2, M>5 or M>10). In an embodiment, a method may comprise determining, controlling and/or optimizing a position of the zone plate structure 822 (e.g., within the probe element 816) so as to maximize the efficiency of the system.

Such a zone plate structure 822 may be formed within probe element 816 via conventional MEMS processing, for example, e.g., via repetitions of deposition and etch steps.

In FIG. 7, the zone plate structure is shown as a linear zone plate structure. However, the zone plate structure may comprise any suitable form, including for example a linear or unidimensional zone plate structure, a two-dimensional (e.g., rectangular) zone plate structure or radial zone plate structure.

FIG. 9 shows two such examples, a rectangular (including square) zone plate structure 900 and a circular or radial zone plate structure 910. The spacing of the elements of the zone plate structure may comprise any (non-constant pitch) spacing which provides a focusing effect.

Focal distance F of the zone plate structure is related to acoustic wavelength λ, the distance d of source to the zone plate and the pitches of the structures in the lens. The mathematical relation between these may be expressed in the formula:

$$d + F + \frac{n λ}{2} = \sqrt{{r}_{n}^{2} + {d}^{2}} + \sqrt{{r}_{n}^{2} + {F}^{2}}$$

where rₙ is the zone plate structure locations (distance from a center structure) or radii where n is an integer (e.g., such that the location of the first feature from the center is r₁, next feature r₂ etc.). Based on this, in an embodiment, and assuming d=F (shown as d below) as the aim is to focus the waves back to the source location (tip of the cantilever) in reflection mode, the zone plate structure feature locations or radii within the proposed target may be determined according to:

$${r}_{n} = \sqrt{{( \frac{( 2 d + \frac{n λ}{2} )}{2} )}^{2} - {d}^{2}} \qquad Equation 1$$

FIG. 10 shows an alternative embodiment to those comprising a zone plate structure as a focusing element. In this embodiment an acoustic convex acoustic lens 1018 is used to focus the generated ultrasonic waves to the tip 1030 of probe element 1016. The acoustic convex acoustic lens 1018 may comprise an ultrasound generation layer or ultrasound generation region on cantilever arm 1014; i.e., ultrasound generation layer as described in WO2021028174A1 and/or a top surface of the cantilever arm 1014 may be provided with a convex shape configured to geometrically focus the generated ultrasound waves towards the tip 1030 due to curvature of the wavefront 1020.

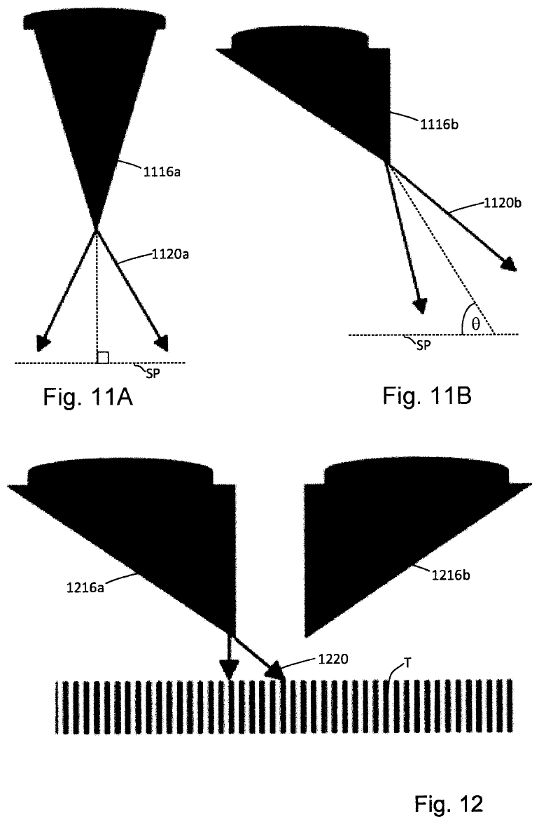

It is further proposed, in an embodiment, that any of the abovementioned embodiments and examples may be combined with one or more angled tips which are configured to direct the generated ultrasonic waves in a direction at a non-normal angle with respect to the target/substrate plane. Such a non-normal angle may be, for example, less than 85 degrees, less than 80 degrees, less than 75 degrees, less than 70 degrees, less than 65 degrees, less than 60 degrees, less than 55 degrees, less than 50 degrees or less than 45 degrees with respect to the substrate plane. FIGS. 11 and 12 will illustrate such embodiments in terms of acoustic probes comprising an acoustic convex acoustic lens, however the concepts are equally applicable to zone plate structure embodiments.

FIG. 11(a) schematically illustrates an acoustic probe 1116a which emits the ultrasonic waves 1120a with a propagation direction normal to a substrate plane SP (i.e., at a conventional angle). FIG. 11(b) schematically illustrates an angled acoustic probe element 1116b which emits the ultrasonic waves 1120b with a propagation direction having a non-normal angle θ with respect to substrate plane SP. Acoustic probe element 1116b may comprise any of the acoustic probes illustrated in FIGS. 7 to 10 and/or disclosed herein. Since the probe tapers down towards the substrate at an angle, the acoustic energy is emitted at an angle inside the target grating. This can be compared to off-axis illumination in optical inspection and can provide more sensitivity for particular 3D grating structures. For example, acoustic probe 1116b may comprise a flat side at a portion of the tip structure, which can allow for a sharper tip; e.g., to enter the trench of a grating feature.

The abovementioned acoustic probe arrangements may be used to measure a parameter of interest such as overlay using the methods described in the aforementioned WO2021028174A1. Briefly, this may comprise measuring a top structure of a target using conventional AFM metrology and then measuring a bottom structure of the target using the passAFM technique. In the methods described, overlay could be extracted either by performing an initial calibration and measurement of a target comprising two biased sub-targets (e.g., per direction), or measurement of a target comprising four biased sub-targets (e.g., per direction) without calibration.

FIG. 12 illustrates an acoustic probe arrangement which may be used to infer overlay from two biased sub-targets (e.g., per direction) without calibration, using a similar principle to μDBO (micro-diffraction based overlay) signal processing.

The acoustic probe arrangement comprises a pair of angled acoustic probes 1216a, 1216b, each being essentially similar and directed to emit acoustic waves 1220 at a common point (i.e., so that they measure the same target in a measurement). Each acoustic probe 1216a, 1216b emits acoustic waves with respective propagation directions defined by equal and opposite non-normal angles with respect to the substrate plane.

This acoustic probe arrangement can be used to detect asymmetry in the grating structure or target T. If the two acoustic probes 1216a, 1216b are excited under identical conditions, the respective signals detected by each tip will also be identical. For an asymmetric grating structure, the two signals detected will also be asymmetric. The differential signal will be proportional to the grating asymmetry (e.g. grating-on-grating overlay or on-product overlay). This is similar in concept to determining an intensity asymmetry from two complementary diffraction orders of a μDBO measurement. The differential signal in this embodiment may show a SIN relation or sin-like relation (e.g., periodic relation) with asymmetry/overlay, and as such a near linear dependency for small overlay values (e.g., smaller than the product pitch). The slope in the zero asymmetry region (over which the relationship is approximately and assumed linear) can be calibrated for (e.g., for on-product overlay), or else determined without calibration using two biased sub-targets. For example, where the sub-targets have an equal magnitude bias of opposite direction +d, −d, overlay OV may be inferred by:

$$OV = d \frac{{Δ}_{+ d} + {Δ}_{- d}}{{Δ}_{+ d} - {Δ}_{- d}}$$

where Δ_{+d} is the differential signal from the positively biased sub-target and Δ_{-d} is the differential signal from the negatively biased sub-target. As is conventional, this may be done per perpendicular direction of the substrate plane.

If the two acoustic probes 1216a, 1216b are closely spaced, the signal generated by one tip in the grating can also be detected by the other tip. This can also be used for detecting grating symmetry.

In all the embodiments described above, the material out of which the zone plate structure is comprised may be chosen to have large photoelastic coefficients, or to be optimized otherwise to facilitate generation and detection of acoustic waves.

Further embodiments according to the present invention are disclosed in below numbered clauses:
1. A cantilever probe arrangement for a photoacoustic sub-surface atomic force microscope comprising: a cantilever arm; at least one probe element attached to the cantilever arm and comprising a cross-sectional area which decreases away from the cantilever arm towards a tip of the probe element; and at least one focusing structure operable to focus acoustic waves generated on the cantilever arm on said tip of the at least one probe element.
2. A cantilever probe arrangement according to clause 1, wherein each said at least one focusing structure comprises a zone plate structure.
3. A cantilever probe arrangement according to clause 2, wherein said zone plate sub-structure comprises a linear zone plate sub-structure.
4. A cantilever probe arrangement according to clause 2, wherein said zone plate sub-structure comprises a rectangular zone plate sub-structure.
5. A cantilever probe arrangement according to clause 2, wherein said zone plate sub-structure comprises a circular zone plate sub-structure.
6. A cantilever probe arrangement according to any of clauses 2 to 5, wherein the zone plate structure is located on a surface of the cantilever arm.
7. A cantilever probe arrangement according to any of clauses 2 to 6, wherein the zone plate structure is located on a detection surface of the cantilever arm, said detection surface being for detecting reflected waves, having been reflected by a target.
8. A cantilever probe arrangement according to any of clauses 2 to 7, wherein the zone plate structure is located on an acoustic generation surface of the cantilever arm, said acoustic generation surface being for generating the acoustic waves.
9. A cantilever probe arrangement according to any of clauses 2 to 5, wherein a respective said zone plate structure is embedded between said cantilever arm and a respective tip within each said at least one probe element.
10. A cantilever probe arrangement according to clause 9, wherein each zone plate structure is embedded within the at least one probe element approximately equidistantly from said cantilever arm and its respective tip.
11. A cantilever probe arrangement according to clause 9, wherein each zone plate structure is embedded within the at least one probe element at a position such that a magnification imposed by the each zone plate structure is greater than 1.
12. A cantilever probe arrangement according to clause 11 wherein said position of the zone plate structure is optimized so as to maximize the efficiency of the cantilever probe arrangement.
13. A cantilever probe arrangement according to any of clauses 2 to 12, wherein the zone plate structure comprises one or more absorber materials.
14. A cantilever probe arrangement according to any of clauses 2 to 13, wherein the zone plate structure comprises one or more metals.
15. A cantilever probe arrangement according to clause 1, wherein the focusing structure comprises a convex acoustic lens.
16. A cantilever probe arrangement according to clause 15, wherein said convex acoustic lens is located on said cantilever arm.
17. A cantilever probe arrangement according to clause 15 or 16, wherein said convex acoustic lens is located on an ultrasound generation surface of said cantilever arm, for generating the acoustic waves.
18. A cantilever probe arrangement according to any preceding clause, wherein said at least one probe element comprises at least one angled probe element configured to emit said acoustic waves at a propagation direction having a non-normal angle with respect to a substrate plane defined by a substrate comprising a target being measured.
19. A cantilever probe arrangement according to clause 18, wherein each at least one probe element comprises a pair of angled probe elements, each said angled probe element of the pair of angled probe elements being configured to emit said acoustic waves at a propagation direction having a respective non-normal angle having the same magnitude with respect to a substrate plane defined by a substrate comprising a target being measured, but opposite direction.
20. A cantilever probe arrangement according to clause 18 or 19, wherein said non-normal angle has a magnitude less than 85 degrees.
21. A cantilever probe arrangement according to clause 18 or 19, wherein said non-normal angle has a magnitude less than 70 degrees.
22. A cantilever probe arrangement according to clause 18 or 19, wherein said non-normal angle has a magnitude less than 60 degrees.
23. A cantilever probe arrangement according to any preceding clause, comprising an electromagnetic detection system for detecting movement of said cantilever arm resultant form reflected acoustic waves, having reflected from a target.
24. A photoacoustic sub-surface atomic force microscope comprising the cantilever probe arrangement according to any preceding clause.

The acoustic probe designs disclosed herein should increase signal strength in the measured signal. In addition, these acoustic probe designs should increase performance by limiting disturbing internal reflections from tip sidewalls. Adding a lens-like structure between the probe tip and cantilever arm provides an additional benefit of re-focusing the returning signal to the probe beam's detection surface (this would normally diverge, leading to even weaker signal). Additionally, upon detection, the zone plate structure may also help suppress spurious signal from internal reflections inside the probe, increasing signal to noise and relaxing probe geometry requirements (probe size, mechanical stability, manufacturing techniques).

Although specific reference may be made in this text to the use of lithographic apparatus in the manufacture of ICs, it should be understood that the lithographic apparatus described herein may have other applications. Possible other applications include the manufacture of integrated optical systems, guidance and detection patterns for magnetic domain memories, flat-panel displays, liquid-crystal displays (LCDs), thin-film magnetic heads, etc.

Although specific reference may be made in this text to embodiments of the invention in the context of an inspection or metrology apparatus, embodiments of the invention may be used in other apparatus. Embodiments of the invention may form part of a mask inspection apparatus, a lithographic apparatus, or any apparatus that measures or processes an object such as a wafer (or other substrate) or mask (or other patterning device). The term “metrology apparatus” may also refer to an inspection apparatus or an inspection system. E.g. the inspection apparatus that comprises an embodiment of the invention may be used to detect defects of a substrate or defects of structures on a substrate. In such an embodiment, a characteristic of interest of the structure on the substrate may relate to defects in the structure, the absence of a specific part of the structure, or the presence of an unwanted structure on the substrate.

Although specific reference is made to “metrology apparatus/tool/system” or “inspection apparatus/tool/system”, these terms may refer to the same or similar types of tools, apparatuses or systems. E.g. the inspection or metrology apparatus that comprises an embodiment of the invention may be used to determine characteristics of structures on a substrate or on a wafer. E.g. the inspection apparatus or metrology apparatus that comprises an embodiment of the invention may be used to detect defects of a substrate or defects of structures on a substrate or on a wafer. In such an embodiment, a characteristic of interest of the structure on the substrate may relate to defects in the structure, the absence of a specific part of the structure, or the presence of an unwanted structure on the substrate or on the wafer.

Although specific reference may have been made above to the use of embodiments of the invention in the context of optical lithography, it will be appreciated that the invention, where the context allows, is not limited to optical lithography and may be used in other applications, for example imprint lithography.

While the targets or target structures (more generally structures on a substrate) described above are metrology target structures specifically designed and formed for the purposes of measurement, in other embodiments, properties of interest may be measured on one or more structures which are functional parts of devices formed on the substrate. Many devices have regular, grating-like structures. The terms structure, target grating and target structure as used herein do not require that the structure has been provided specifically for the measurement being performed.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

1.-15. (canceled)

16. A cantilever probe arrangement for a photoacoustic sub-surface atomic force microscope comprising:
a cantilever arm;
at least one probe element attached to the cantilever arm and comprising a cross-sectional area that decreases in size away from the cantilever arm towards a tip of the probe element; and
at least one focusing structure operable to focus acoustic waves generated on the cantilever arm on the tip of the at least one probe element.

17. The cantilever probe arrangement of claim 16, wherein each the at least one focusing structure comprises a zone plate structure.

18. The cantilever probe arrangement of claim 17, wherein the zone plate structure is located on a surface of the cantilever arm.

19. The cantilever probe arrangement of claim 17, wherein the zone plate structure is located on a detection surface of the cantilever arm, wherein the detection surface is configured to detect reflected waves, having been reflected by a target.

20. The cantilever probe arrangement of claim 17, wherein the zone plate structure is located on an acoustic generation surface of the cantilever arm, wherein the acoustic generation surface is configured to generate the acoustic waves.

21. The cantilever probe arrangement of claim 17, wherein a respective the zone plate structure is embedded between the cantilever arm and a respective tip within each of the at least one probe element.

22. The cantilever probe arrangement of claim 17, wherein the zone plate structure comprises one or more absorber materials.

23. The cantilever probe arrangement of claim 17, wherein the zone plate structure comprises one or more metals.

24. The cantilever probe arrangement of claim 16, wherein the focusing structure comprises a convex acoustic lens and the convex acoustic lens is located on the cantilever arm.

25. The cantilever probe arrangement of claim 24, wherein the convex acoustic lens is located on the cantilever arm.

26. The cantilever probe arrangement of claim 24, wherein the convex acoustic lens is located on an ultrasound generation surface of the cantilever arm, and is configure to generate the acoustic waves.

27. The cantilever probe arrangement of claim 16, wherein the at least one probe element comprises at least one angled probe element configured to emit the acoustic waves at a propagation direction having a non-normal angle with respect to a substrate plane defined by a substrate comprising a target being measured.

28. The cantilever probe arrangement of claim 16, wherein the at least one probe element comprises a pair of angled probe elements, each angled probe element of the pair of angled probe elements being configured to emit the acoustic waves at a propagation direction having a respective non-normal angle having a same magnitude with respect to a substrate plane defined by a substrate comprising a target being measured, but opposite direction.

29. The cantilever probe arrangement of claim 16, comprising an electromagnetic detection system configured to detect movement of the cantilever arm resulting form reflected acoustic waves, having reflected from a target.

30. A photoacoustic sub-surface atomic force microscope comprising the cantilever probe arrangement of claim 16.
